(19) United States
(12) Patent Application Publication
(10) Pub. No.: US 2007/0091348 A1
(43) Pub. Date: Apr. 26, 2007

(54) Image forming device

(76) Inventor: Hitoshi Asaka, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,088

(22) Filed: Oct. 26, 2005

(51) Int. Cl. G06K 15/00

(52) U.S. Cl. 358/1.14; 358/1.13

(57) ABSTRACT

In an image forming device that does not authorize a copy operation when a predefined sheet limit is exceeded, if the count value of prints by a printing unit is detected to have reached 90% of a predefined limiting count (YES in S12), a copier automatically performs memory copy, in which the output is to a memory (DRAM), instead of printing onto a sheet of paper (S13). Following the memory copy, a necessary count is calculated, and if the sheet limit is exceeded, notice is made (S17).

### FIELD OF THE INVENTION

This invention relates to an image forming device, and more specifically to an image forming device having a department management function.

### BACKGROUND INFORMATION

Image forming devices having a department management function-are known, in which the number of copies that are allowed to be made or the like is predefined for corporate departments or the like, so that it is not possible to make copies exceeding this number. In an image forming device having such a department management function, methods are known, for example, for handling cases in which a preset copy number is exceeded.

According to this method, if the number of copies that is set when setting the copy number exceeds the remaining number of copies managed by the department management function in an image forming device, a warning is displayed and, depending on a preset reserve mode, the image data is discarded or the copy number is automatically reduced so as to allow for processing with a number of copies that does not exceed the remaining number of copies.

In a conventional image forming device having a department management function, the method for handling cases in which a preset copy number is exceeded, is performed as described above.

However, in a process such as the one described above, as the notice is issued when the sheet limit has been reached, because the number of required copies set by the user cannot be obtained, the user is dissatisfied.

In addition, there is a problem that, although the situation can be handled beforehand if the number of documents or the number of copies is known, the situation cannot be handled if the number of copies is unknown at the beginning of printing, such as when printing is performed at the same time as reading.

This invention was devised in view of problems such as those described above, and an object thereof is to provide an image forming device having a department management function with which a user can handle such situations as those in which the number of documents is not known beforehand.

### SUMMARY OF THE INVENTION

According to this invention, an image forming device that does not authorize a copy operation when an image formation count exceeds a predefined limiting count comprises: an image forming means for forming an image; a counting means for counting a predetermined number images formed by the image forming means; a first detection means for detecting that the count value of the counting means has reached a predetermined value that is smaller than the limiting count; and a control means for, when the first detection means detects that the predetermined value has been reached, automatically controlling the image forming means to perform a predetermined operation, so as not to exceed the limiting count.

Preferably, the predetermined operation is an operation that automatically changes the output by the image forming means to a memory copy.

More preferably, the image forming device comprises a display means, and the predetermined operation is displaying on the display means a count remaining available before the limiting count.

The detection means comprises a second detection means for detecting that the count value according to the counting means has reached the limiting count, and when the second detection means detects that the limiting count has been reached, the control means notifies the user of a way to reduce this count value, if a way to reduce the count value exists.

According to another aspect of this invention, the image forming device, which does not authorize a copy operation when an image formation count exceeds a predefined limiting count, comprises: an image forming means for forming an image; a counting means for counting a cumulative count value, to which a count value for new image formation by the image forming means has been added prior to outputting to a sheet of paper; a means for determining whether or not the cumulative count value according to the counting means exceeds the limiting count; and a control means for, if the determination means determines that the limiting count is exceeded, controlling so as to make this known, and notifying the user of a way to avoid exceeding the limiting value, if a way to avoid exceeding the limiting value exists.

Preferably, the ways to avoid exceeding the limiting value include an image forming method in which an image forming condition has been modified.

In this invention, when the image formation count by the image forming means is detected to have reached a predetermined value that is less than the limiting count, the image forming means is automatically controlled so as not to exceed the limiting count.

When the image formation count exceeds the predetermined count value that is less than the limiting count, a process for not exceeding the limit count is automatically performed; thus, an image forming device having a department management function capable of optimal copying, from the point of view of the user, can be provided even in situations such as those wherein the number of documents is unknown beforehand.

In another aspect of this invention, when a cumulative count value, to which a count value for new image formation by the image forming means has been added prior to outputting onto a sheet of paper, is determined to exceed the limiting count, a notice is issued, and the user is notified of a way to avoid exceeding the limiting value, if a way to avoid exceeding the limiting value exists.

As a result, the user can carry out the desired image formation within the limit count.

### BRIEF DESCRIPTION OF THE DRAWINGS

FIG. 1 is a block diagram showing the constitution of a multi-function machine.

FIG. 2 is a view showing an operation unit.

FIG. 3 is a flowchart showing operations in a first mode of embodiment of this invention.

FIG. 4 is a flowchart showing variant operations in a first mode of embodiment of this invention.

FIG. 5 is a flowchart showing operations in a second mode of embodiment of this invention.

### DETAILED DESCRIPTION OF THE PREFERRED EMBODIMENTS

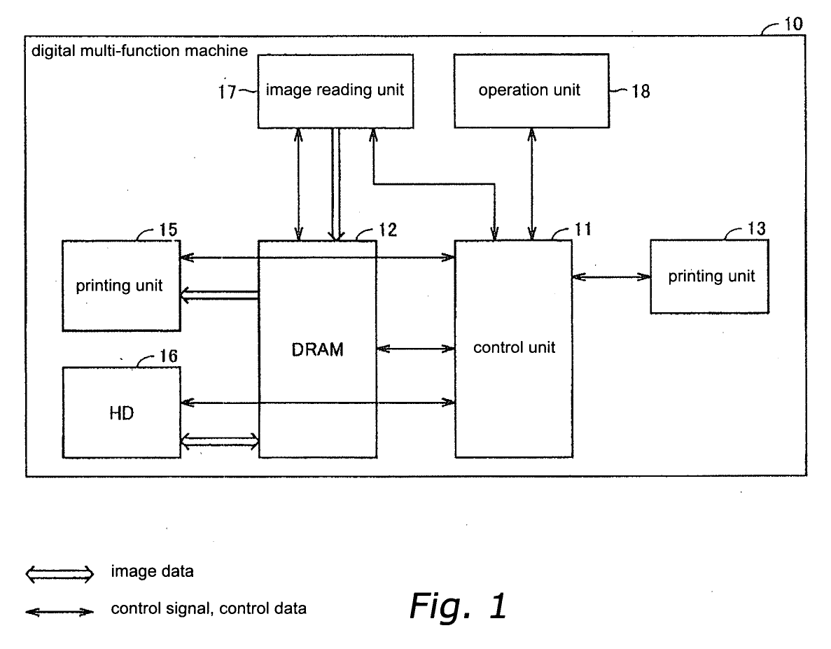

Hereinafter, the modes of embodiment of this invention will be described with reference to the figures. FIG. 1 is a block diagram showing the constitution of a copier as one example of image forming device having a department management function according to one mode of embodiment of this invention. Referring to FIG. 1, a copier 10 comprises a control unit 11 for controlling the entirety of the copier 10 and functioning as a counting means, a detection means and a control means; a DRAM 12; a printing unit 15 for functioning as an image forming means; a hard disk HD 16; an image reading unit 17; an operation unit 18; and a print counter 13 for counting the number of sheets printed by the printing unit 15.

The image reading unit 17 comprises a CCD (not shown), which is an example of photoelectric conversion element, and can read image data from a document.

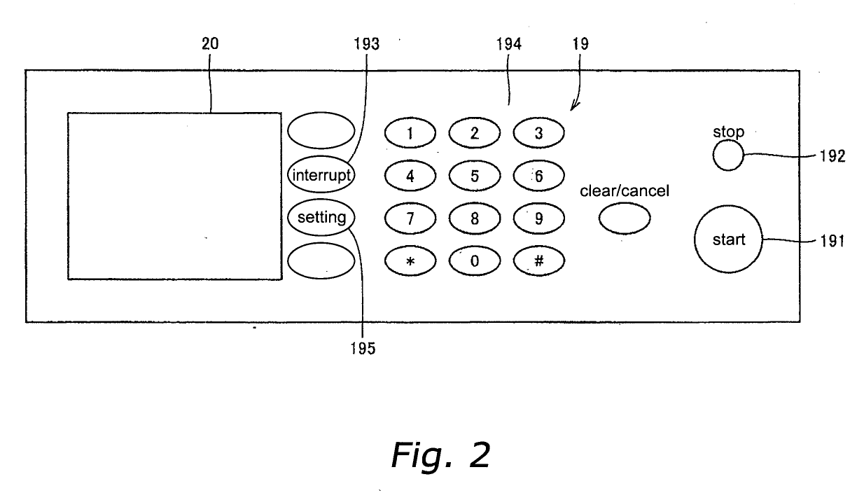

As shown in FIG. 2 the operation unit 18 comprises an input unit 19 and a display unit 20; the input unit 19 comprises a start key 191 for specifying the start of copying, a stop key 192 for entirely canceling an executing process, an interruption key 193 for specifying the execution/cancellation of an interruption, a numeric keypad 194 for specifying the number of copies or the like, a setting key 195 for setting various information, and the like.

The display unit 20 comprises a liquid crystal panel, and can display information provided by the copier 10 for a user. This liquid crystal panel is a touch panel, which also functions as part of the input unit 19.

The control unit 11 compresses and encodes data given by the image reading unit 17 to write to the DRAM 12, and reads, expands and decodes the data written in DRAM 12 to output. In addition, the control unit 11 performs control for printing by the printing unit 15, control for image reading by the image reading unit 17, control for entering data from the input unit 19 of the operation unit 18, control for displaying data onto the display unit 20 of the operation unit 18, and the like.

It should be noted that in FIG. 1, a heavy lined arrow indicates the flow of image data, and a thin lined arrow indicates the flow of control signals or control data.

In addition, printing limitations for a department management function include (i) a limitation on the number of copies actually delivered onto sheets of paper (limit on sheets used) and (ii) a limitation on the number if times that the printing unit 15 is used (limit on copies made) where printing to an A3 sized sheet is counted as twice printing to an A4 sized sheet and color printing is counted a four times a monochrome print.

Hereinafter, description will principally be made of a process in which the limit on sheets used serves as the limiting count.

(1) First Mode of Embodiment

The operation of this copier 10 will be described. First, the first mode of embodiment will be described.

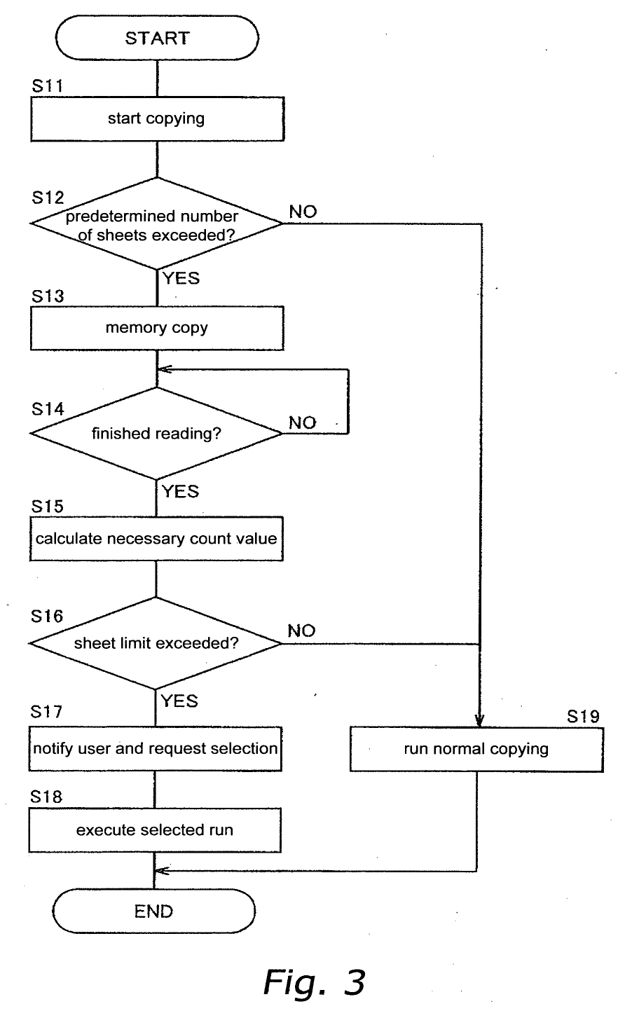

FIG. 3 is a flowchart showing operations in the first mode of embodiment. It is assumed that in the copier 10, a sheet limit (limiting count) L and a number X of sheets currently used are pre-stored on a hard disk 16 or the like, for each department to which users belong. In addition, when a user makes a copy, the number of prints thereof is counted by the print counter 13 and added to the number X of sheets used for the department the user belongs to.

Referring to FIG. 3, the user enters the name of the department that the user belongs to, so as to start copying (step S11; hereinafter, the term “step” will be omitted). This input of the department name is performed by inputting numbers by way of the numeric keypad, or by inserting a card for the department in a card reader or the like, which is not shown.

The control unit 11 refers to the sheet limit L of the user's department, and calculates a predetermined number of sheets a that is smaller by a given number of copies than this sheet limit L (for example, 90% of the sheet limit). In this state, the copier 10 determines whether or not the number of sheets used X exceeds the predetermined number of sheets a (S12).

If the number of sheets used X is determined to exceed the predetermined number of sheets α, the control unit 11 does not print directly onto paper, but copies the print data into the DRAM (memory) 12 instead. This is referred to as memory copy (S13). Normally, this process is also performed also when copying and reading at the same time.

When the reading is finished (YES in S14), the count value needed for this copy run is calculated (S15). This count value is the necessary count, as obtained from the product of the number of documents and the number of copies entered by the user. Furthermore, in terms of this count value, if for example the copy size is A3, one sheet is counted as 2, if the setting is 2-in-1 or 4-in-1, each sheet is counted as 1, and if the copy is in color, the corresponding number of sheets is counted.

Next, it is determined whether or not the count value obtained by adding the count value needed for the above copy operation to the previous count value exceeds the sheet limit L (S16). If it is determined to exceed (YES in S16), the user is informed that the number of copies set will exceed the sheet limit L, and is also informed of the available number of sheets (available count value), for example, by way of the display unit 20; the user is then asked whether or not to continue the print run (S17).

In response thereto, the user enters whether or not to continue the print run by way of the display unit 20, and the copier 10 performs the process according to the user's input (S18).

If the number of sheets used X is determined to be less than or equal to the predetermined number of sheets in S12, or if it is determined not to exceed the sheet limit L in S16, a normal copy operation is performed (S19).

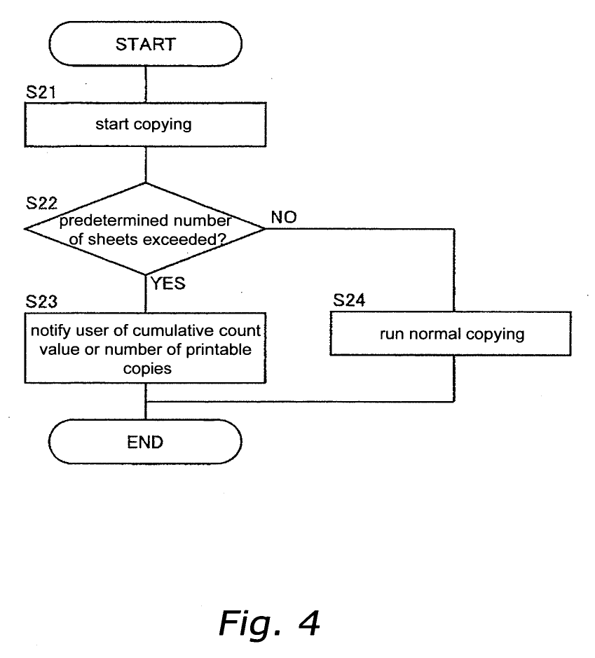

Next, a variant of this mode of embodiment will be described. FIG. 4 is a flowchart showing the operations for this variant.

Referring to FIG. 4, the variant is the same up to the determination of whether or not the predetermined number of sheets a is exceeded as in the previous mode of embodiment; however, when the predetermined number of sheets α is determined to have been exceeded (YES in S22), the user is notified of the number of sheets currently used X, or the remaining printable number of sheets (S23). This notification is performed, for example, by way of the display unit 20, so that the user knows before starting the operation.

In this way, the fact that the sheet limit L for the department is approaching can be brought to the attention of the user by not performing the display when the sheet limit L is not imminent, and by performing the display only when necessary.

As described above, according to the first mode of embodiment of this invention, in a copier managed by department, when a predetermined number of sheets α that is close to the sheet limit L will be exceeded, memory copy is performed, or the user is notified to that effect, so that the user is not in the difficult position of responding to a sudden announcement to the effect that sheet limit L has already been reached.

(2) Second Mode of Embodiment

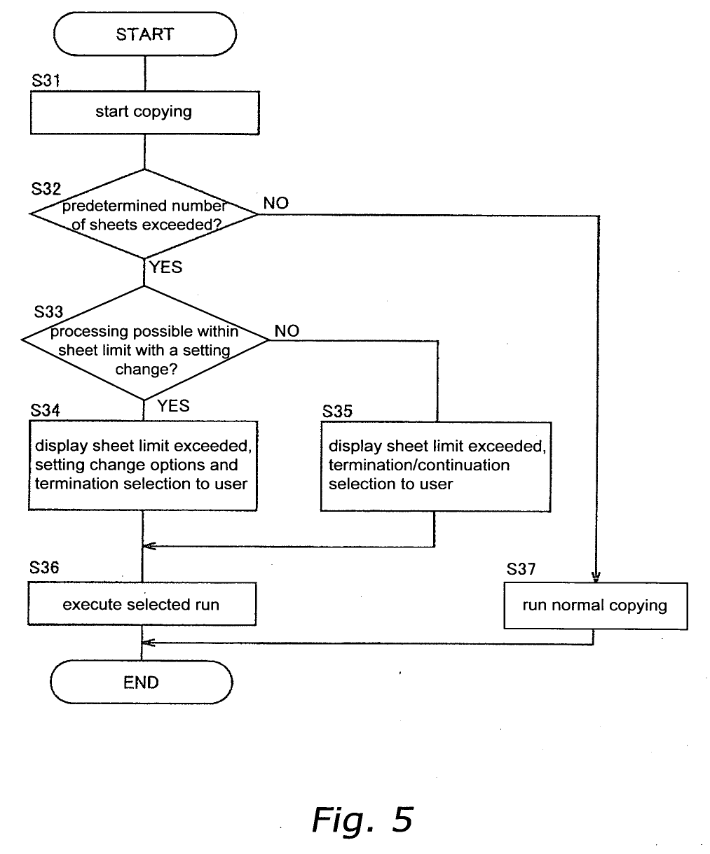

Next, the second mode of embodiment of this invention will be described. FIG. 5 is a flowchart showing the operation of a copier 10 according to another mode of embodiment of this invention. It is also assumed in this mode of embodiment that a sheet limit L and the number of sheets currently used X, for each department to which users belong are pre-stored on a hard disk 16 or the like in the copier 10, and this mode of embodiment is the same as the previous mode of embodiment regarding the user entering the name of the department to which the user belongs so as to start copying (S31), and the control unit 11 referring to the sheet limit L of the user's department to obtain the sheet limit L.

However, in this mode of embodiment, in contrast to the previous mode of embodiment, the control unit 11 determines whether or not the number of sheets used X by the user exceeds the sheet limit L, from the user copy setting (S32).

In addition, when copying starts, first the count needed for new image formation is counted, and this is added to the previous count value to determine the cumulative count value, before actually printing onto a sheet of paper.

Next, a method for determining whether or not the sheet limit L will be exceeded based on the user setting will be described. The user places a document on the image reading unit 17, while at the same time using the numeric keypad of the operation unit 18 to set the desired number of copies on the display unit 20. The copier 10 reads the documents to determine the number of sheets, and calculates the necessary cumulative count from the number of documents and the number of copies set. This cumulative count value and the sheet limit L are compared.

In S32, when the cumulative count value calculated based on the setting performed by the user is determined to exceed the sheet limit L, the control unit 11, by way of the display unit 20, checks with the user to see whether or not it is possible to stay within the sheet limit L by changing the setting (S33).

In this checking, as the number of documents cannot be reduced, the following processes, such as reducing the number of copies, are possible.

(i) Use the 2-in-1 or 4-in-1 function to reduce the number of prints (effective for the number of prints and the number of sheets used).

(ii) Change the output sheet size that is set to A3 to A4 (effective for the number of prints).

(iii) Change the sheet size. Reduce the copy size from a double-count size such as A3 to a single-counted size (effective for the number of prints).

(iv) Change from full-color copy to monochrome copy. The sheet size and the number of sheets used remain the same, but this can change the count from four to one (effective for the number of prints).

(v) Change from one-sided copy to double-sided copy. (effective for the number of sheets used).

When checking, if processing is possible within the sheet limit L by making a change to the setting (YES in S33), the control unit 11 shows to the user on the display unit 20 a display indicating that the sheet limit L is exceeded, indicating the changes that are available to allow for processing, and allowing the user to select cancellation of the process (S34).

If processing is not possible within the sheet limit L even after making a change to the setting (NO in S33), the user is informed by way of the display unit 20 that the sheet limit L is exceeded and that no setting change that allows for processing exists, and a display is shown on the display unit 20 allowing the user to select cancellation of the process (S35).

Thereafter, the process waits for the selection made by the user and follows this instruction (S36).

If the sheet limit L is not exceeded in S32, a normal copy operation is performed (S37).

It should be noted that, although determination of whether or not the sheet limit L is exceeded is performed after the all the documents have been read in the above embodiment, the invention is not limited to this, and the copy operation can be performed without counting the number of documents. In this case, as the number of necessary copies is unknown, when the remaining number of copies nears a predetermined number of sheets from the sheet limit L, from that point on, memory copy to the DRAM 12 may be performed instead of making actual copies.

In this case, the predetermined number of sheets may be determined by assuming that an ordinary document comprises 10 sheets, and fixing the number of sets of copies that can be made (for example, 10 sets), and thus the product thereof may be defined as the predetermined number of sheets.

In addition, although in the above embodiment descriptions were given separately for when the predetermined number of sheets is exceeded and when the sheet limit L is exceeded, the present invention is not limited thereto, and for example, in the process of FIG. 3 for determining whether or not the predetermined number of sheets is exceeded, the processes for determining whether or not “sheet limit exceeded?” in S16 and subsequent steps may be replaced with the processes in S32 and subsequent steps in FIG. 5. In this way, when the sheet limit L is exceeded, whether or not processing is possible within the sheet limit by making a setting change is determined, which is a more precise responsiveness to the user.

In the foregoing, although the modes of embodiment of this invention were described with reference to the figures, this invention is not limited to the illustrated modes of embodiment. Various perfections and variations can be applied to the illustrated modes of embodiment within the scope of the invention or an equivalent scope thereto.

What is claimed is:

1. An image forming device, which does not authorize a copy operation when an image formation count exceeds a predefined limiting count, comprising:
an image forming means for forming an image;
a counting means for counting a predetermined number images formed by the image forming means;
a first detection means for detecting that the count value of the counting means has reached a predetermined value that is smaller than the limiting count; and
a control means for, when the first detection means detects that the predetermined value has been reached, automatically controlling the image forming means to perform a predetermined operation, so as not to exceed the limiting count.

2. The image forming device as recited in claim 1, wherein the predetermined operation is an operation that automatically changes the output by the image forming means to a memory copy.

3. The image forming device as recited in claim 1, wherein the image forming device comprises a display means, and
the predetermined operation is displaying on the display means a count remaining available before the limiting count.

4. The image forming device as recited in claim 2, wherein the detection means comprises a second detection means for detecting that the count value according to the counting means has reached the limiting count, and
when the second detection means detects that the limiting count has been reached, the control means notifies the user of a way to reduce this count value, if a way to reduce the count value exists.

5. An image forming device, which does not authorize a copy operation when an image formation count exceeds a predefined limiting count, comprising:
an image forming means for forming an image;
a counting means for counting a cumulative count value, to which a count value for new image formation by the image forming means has been added prior to outputting to a sheet of paper;
a means for determining whether or not the cumulative count value according to the counting means exceeds the limiting count; and
a control means for, if the determination means determines that the limiting count is exceeded, controlling so as to make this known, and notifying the user of a way to avoid exceeding the limiting value, if a way to avoid exceeding the limiting value exists.

6. The image forming device as recited in claim 5, wherein the ways to avoid exceeding the limiting value include an image forming method in which an image forming condition has been modified.
